(19) United States
(12) Patent Application Publication
(10) Pub. No.: US 2008/0074822 A1
(43) Pub. Date: Mar. 27, 2008

(54) Electrically excited load full voltage actuation reduced voltage sustaining driving circuit

(76) Inventor: Tai-Her Yang, Si-Hu Town (TW)

Correspondence Address: BACON & THOMAS;4th Floor, 625 Slaters Lane, Alexandria, VA, 22314-1176, US

(21) Appl. No.: 11/526,587

(22) Filed: Sep. 26, 2006

(51) Int. Cl. H01H 9/00

(52) U.S. Cl. 361/154

(57) ABSTRACT

The present invention is related to a device for the control of electrically excited magnetic load such as electromagnetic braking device, electromagnetic clutch, electromagnetic switch, electromagnetic relay, electromagnetic valve, electromagnetic iron, electromagnetic lock, and toroidal coil, etc., or driving coils installed on the excited windings of electromotor or generator, for the full voltage actuation and reduction of excited winding voltage and for sustaining the operation of electrical excitation through the reduction of voltage for saving of energy.

### BACKGROUND OF THE INVENTION

(a) Field of the Invention

The present invention is to use impedance component and switch device to match with the excitation coils of electromagnetic in order to provide the full voltage actuation of excitation coil, then switch to reduction of excited winding voltage while maintain the operation of electrical excitation for reduction of electrical current. This invention can be used for the application of electromagnetic braking device, electromagnetic clutch, electromagnetic switch, electromagnetic relay, electromagnetic valve, electromagnetic iron, electromagnetic lock, and toroidal coil, or driving coils installed on the excitation windings of electromotor or generator.

(b) Description of the Prior Art

Conventionally electrical current is used to pass through the excitation coil to generate the electrical excitation loading for the operation of electromagnetic effect, whereby the installed excitation coil actuates and sustains the operation of electrical excitation, usually are in full voltage electrical states. The excitation current required is larger and is its drawback.

### SUMMARY OF THE INVENTION

The present invention is related to a device for the control of electrically excited magnetic load such as electromagnetic braking device, electromagnetic clutch, electromagnetic switch, electromagnetic relay, electromagnetic valve, electromagnetic iron, electromagnetic lock, and toroidal coil, etc., or driving coils installed on the excited windings of electromotor or generator, for the full voltage actuation and reduction of excited winding voltage and for sustaining the operation of electrical excitation through the reduction of voltage for saving of energy.

### BRIEF DESCRIPTION OF THE DRAWINGS

FIG. 1 is a circuit block chart of the present invention.

FIG. 2 is a schematic view showing circuit from FIG. 1 with impedance body in parallel with capacitor for the replacement of switch device.

### DETAILED DESCRIPTION OF THE PREFERRED EMBODIMENTS

The present invention uses impedance component and switch device to match with the excitation coils of electromagnetic braking device in order to provide the full voltage actuation of excitation coil; through the switching of switch device to reduce the voltage of excitation winding in order to reduce electrical current while still maintains the operation of electrical excitation for reducing electrical current. This invention could be for the application of electromagnetic braking device, electromagnetic clutch, electromagnetic switch, electromagnetic relay, electromagnetic valve, electromagnetic iron, electromagnetic lock, and toroidal coil, or driving coils installed on the excitation windings of electromotor or generator, etc.

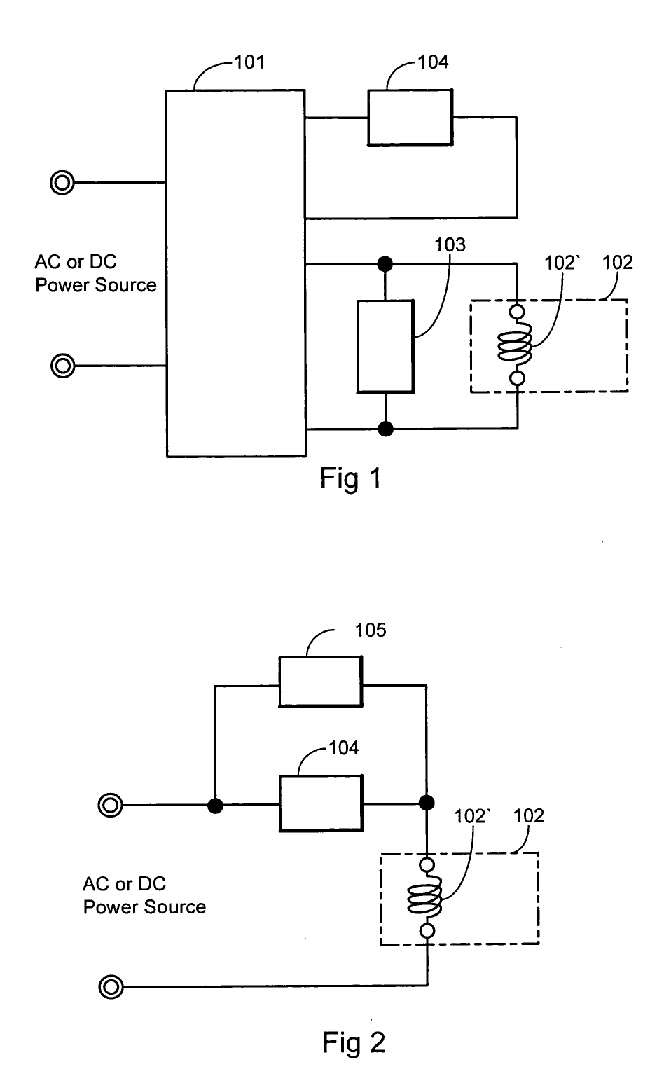

FIG. 1 is a circuit block chart of the present invention, essentially comprised of:

Switch device 101: mechanical or electrical switches, relay, electromagnetic switch or solid state switch component and related operating circuit; operated by human power, or mechanical power, or fluid power, or electrical energy; using alternating or direct current energy to deliver to electrical excitation load 102 or for cutting off electricity; for the switching and operation of switch device 101 for the full voltage actuation of electrically excited loading; then switch over to connecting the excitation coil 102′ and impedance 104 in series for reducing the voltage of excitation coil 102′ in order to reduce electrical current while still can maintain the operation of electrical excitation;

Electrical excitation load 102: an electromagnetic actuating device with electrical excitation coil 102′, consists of devices such as electromagnetic braking device, electromagnetic clutch, electromagnetic switch, electromagnetic relay, electromagnetic valve, electromagnetic iron, electromagnetic lock, and toroidal coil, etc. or driving coils installed on the excited windings of electromotor or generator;

Capacitor 103: AC or DC capacitor selected to match based on the specification of electrically excited load 102; or other component that could store and discharge electricity, that can provide assistance to the coil 102′ of electrically excited load 102 to maintain stable operation when switching the switch device 101 between series and parallel connections to excitation coil 102′. Such capacitor 103 can either be installed or not installed based on the need;

Impedance body 104: (1) when used in DC power, impedance body 104 consists of coil with resistive, or resistive impedance, or other resistive impedance component or device; when actuated through the switching control of switch device 101 that makes the two ends of the impedance body 104 short circuited so as to using full voltage to drive excitation coil 102′; after actuation the switch devices 101 on the two sides of impedance body 104 are switched to open circuit so as to make impedance body 104 and excitation coil 102′ connected in series and lower the end voltage of the excitation coil 102′ to reduce electrical current while the excitation coil 102′ still can maintain electrically excited operation; (2) when used in AC power, impedance body 104 consists of resistive, inductive, or capacitive impedance component, or halve wave rectification diode, etc.; when actuated through the switching control of switch device 101 that makes the two ends of the impedance body 104 short circuited so as to use full voltage to drive excitation coil 102′; after actuation the switch devices 101 on the two sides of impedance body 104 switched to open circuit and make impedance body 104 and excitation coil 102′ to connect in series and lower the end voltage of the excitation coil 102′ to reduce electrical current while the excitation coil 102′ still can maintain electrically excited operation.

This electrically excited load full voltage actuation reduced voltage sustaining driving circuit, when used in DC power, further can be as shown in FIG. 2, which is the illustration of the circuit modified from FIG. 1 by using an impedance body in parallel with a capacitor to replace the switch device. In FIG. 2 is using the capacitor 105 in parallel with impedance body 104 to replace switch device 101, when actuated the capacitor 105 is charged through excitation coil 102′, now form the full voltage actuation function, after actuation, when the charging voltage of capacitor 105 is in balance with the end voltage of impedance 104, the impedance body 104 to electrically excited load 102 forms reducing voltage function.

This electrically excited loading full voltage actuation reduced voltage sustaining driving circuit, of which the applicable electrically excited loading when actually applied can select based on the needs with different characteristic electrical power driving device at different voltage as electrically excited load, application device such as (1) with excitation coil having electrical magnetic effect including: electromagnetic actuator device, electromagnetic clutch, electromagnetic switch, electromagnetic relay, electromagnetic valve, electromagnetic iron, electromagnetic lock, and toroidal coil, etc., or driving coils installed on the excited windings of (2) electromotor or (3) generator, and based on the need select from above loading one kind or more than one kind of same or different electrical power driving device constituting electrical power load.

In summary, this electrically excited load full voltage actuation reduced voltage sustaining driving circuit, on full voltage action, through the control of switch device 101, using the end voltage and current of the reducing electrically excited load 102 excitation coil 102′ for saving electrical energy, is indeed having pertinent function, therefore hereby proposes patent application.

1. A kind of electrically excited load full voltage actuation reduced voltage sustaining driving circuit, for the control of electrically excited load such as electromagnetic actuator device, electromagnetic clutch, electromagnetic switch, electromagnetic relay, electromagnetic valve, electromagnetic iron, electromagnetic lock, and toroidal coil, etc., or driving coils installed on the excited windings of electromotor or generator, for the full voltage actuation and reduction of excited winding voltage and for sustaining the operation of electrical excitation through the reduction of voltage for saving of energy, with the major constituents as shown below:
Switch device (101): mechanical or electrical switches, relay, electromagnetic switch or solid state switch component and related operating circuit; operated by human power, or mechanical power, or fluid power, or electrical energy; using alternating or direct current energy to deliver to electrical excitation load (102) or for cutting off electricity; for the switching and operation of switch device (101) for the full voltage actuation of electrically excited loading; then switch over to connecting the excitation coil (102′) and impedance body (104) in series for reducing the voltage of excitation coil (102′) in order to reduce electrical current while still can maintain the operation of electrical excitation;
Electrical excitation load (102): an electromagnetic actuating device with electrical excitation coil (102′), consists of devices such as electromagnetic braking device, electromagnetic clutch, electromagnetic switch, electromagnetic relay, electromagnetic valve, electromagnetic iron, electromagnetic lock, and toroidal coil, etc. or driving coils installed on the excited windings of electromotor or generator;
Capacitor (103): AC or DC capacitor selected to match based on the specification of electrically excited load (102); or other component that could store and discharge electricity, that can provide assistance to the coil (102′) of electrically excited load (102) to maintain stable operation when switching the switch device (101) between series and parallel connections to excitation coil (102′); such capacitor (103) can either be installed or not installed based on the need;
Impedance body (104): (1) when used in DC power, impedance body (104) consists of coil with resistive, or resistive impedance, or other resistive impedance component or device; when actuated through the switching control of switch device (101) that makes the two ends of the impedance body (104) short circuited so as to using full voltage to drive excitation coil (102′); after actuation the switch devices (101) on the two sides of impedance body (104) are switched to open circuit so as to make impedance body (104) and excitation coil (102′) connected in series and lower the end voltage of the excitation coil (102′) to reduce electrical current while the excitation coil (102′) still can maintain electrically excited operation; (2) when used in AC power, impedance body (104) consists of resistive, inductive, or capacitive impedance component, or halve wave rectification diode, etc.; when actuated through the switching control of switch device (101) that makes the two ends of the impedance body (104) short circuited so as to use full voltage to drive excitation coil (102′); after actuation the switch devices (101) on the two sides of impedance body (104) switched to open circuit and make impedance body (104) and excitation coil (102′) to connect in series and lower the end voltage of the excitation coil (102′) to reduce electrical current while the excitation coil (102′) still can maintain electrically excited operation.

2. The electrically excited load full voltage actuation reduced voltage sustaining driving circuit as claimed in claim 1, wherein when applied to DC power, further can be the capacitor (105) in parallel with impedance body (104), replacing switch device (101), when actuated charging capacitor (105) through excitation coil (102′), at this time forms full voltage actuation function, after actuated the charging voltage of capacitor (105) in balance with the end voltage of impedance body (104), constitutes reduced voltage function of impedance body (104) to electrically excited load (102).

3. The electrically excited load full voltage actuation reduced voltage sustaining driving circuit as claimed in claim 1, wherein the electrically excited load selected in the actual application, can select the electrical power driving device with different characteristics at different voltage as electrically excited load, as (1) with excitation coil having electrical magnetic effect including: electromagnetic actuator device, electromagnetic clutch, electromagnetic switch, electromagnetic relay, electromagnetic valve, electromagnetic iron, electromagnetic lock, and toroidal coil, etc., or driving coils installed on the excited windings of (2) electromotor or (3) generator, and based on the need select from above loading one kind or more than one kind of same or different electrical power driving device constituting electrical power load.
